(19) United States
(12) Patent Application Publication
(10) Pub. No.: US 2021/0144473 A1
(43) Pub. Date: May 13, 2021

(54) POSITION DETECTING DEVICE

(71) Applicant: Yamaha Corporation, Hamamatsu-shi (JP)

(72) Inventor: Akira ARAI, Hamamatsu-shi (JP)

(21) Appl. No.: 17/101,740

(22) Filed: Nov. 23, 2020

Related U.S. Application Data
(63) Continuation of application No. PCT/JP2019/032745, filed on Aug. 22, 2019.

(30) Foreign Application Priority Data
Sep. 7, 2018 (JP) 2018-167513

(51) Int. Cl. H04R 3/02; G01D 5/34; H04R 29/00

(52) U.S. Cl. CPC H04R 3/02; H04R 29/001; G01D 5/342

(57) ABSTRACT

A position detecting device is provided for detecting a position of a vibrating portion. The position detecting device can include at least one position detecting portion. The position detecting portion includes a light emitting portion, a light detecting portion for detecting light emitted from the light emitting portion, and a light blocking portion, attached to the vibrating portion and positioned between the light emitting portion and the light detecting portion, having a width that increases gradually along the direction of vibration of the vibrating portion.

### BACKGROUND OF THE INVENTIONS

### Field of Technology

The present inventions relate to position detecting devices for detecting the position of a vibrating portion that vibrates in a specific direction, such as the vibrating portion of a speaker unit.

### Description of the Related Art

There is a known speaker system that performs MFB (Motional Feed Back) control of a speaker unit. In this speaker system, the position of a vibrating portion of a speaker unit, such as a bobbin, or the like, is detected by a position detecting device, where a position detecting signal is fed back to a driving signal inputting portion of a speaker unit through a feedback circuit. Japanese Unexamined Utility Model Registration Application Publication S54-96231 (JP S54-96231), and Japanese Unexamined Patent Application Publications 2008-228212 (JP 2008-228212), and 2008-228216 (JP 2008-228216) disclose position detecting devices used in speaker systems wherein this type of MFB control is carried out.

In the position detecting device disclosed in JP S54-96231, a light emitting portion and a light detecting portion are disposed on either side of a slit (a square hole in JP S54-96231) that is formed in a bobbin which forms the vibrating portion. The light detecting portion has two light detecting diodes aligned in the direction of movement of the slit. The position detecting device comprises a differential amplifier circuit for outputting, as a position detection signal, the difference between output signals from these two light detecting diodes. When the position of the slit moves due to vibration of the vibrating portion, the balance between the amounts of light that has passed through the slit and that is detected by the two light detecting diodes will vary, producing a position detection signal wherein the signal strength varies depending on the changing position of the vibrating portion. Below, such a position detecting device will be referred to as a position detecting device that uses a slit technique.

In the position detecting device disclosed in JP 2008-228212, an edge of a light blocking portion that vibrates together with the vibrating portion moves through the optical path between the light emitting portion and the light detecting portion. The light detecting portion outputs a position detection signal of a signal strength that depends on the amount of light received from the light emitting portion. When the position of the edge of the light blocking portion varies through vibration of the vibrating portion, there will be a change in the amount of light that, of the light that is directed to the light detecting portion from the light emitting portion, is blocked by the light blocking portion. Because of this, a position detection signal wherein the signal strength varies depending on the changing position of the vibrating portion is produced by the light detecting portion. In the below, such a position detecting device will be referred to as a position detecting device that uses a knife edge technique.

JP 2008-228216 discloses a position detecting device that, similarly to JP 2008-228212, uses a knife edge technique. In JP 2008-228216, a paper cone, which is the vibrating portion, is used as the light blocking portion that blocks light that is directed toward the light detecting portion from the light emitting portion.

### SUMMARY OF THE INVENTIONS

In position detecting devices that use the slit technique or the knife edge technique, described above, the range over which the position is detected, that is, the range over which there is a change in signal strength of the position detection signal in response to a change in the position of the vibrating portion, is limited by the diameter of the light beam that arrives on the light detecting portion from the light emitting portion. Because of this, there is a problem in that it is difficult to detect the change in position of the vibrating portion if the vibration stroke of the vibrating portion is long. Additionally, in a position detecting device that uses the slit technique or the knife edge technique, described above, when there is a need to widen the range over which the position is detected, it has been necessary to expand the radiation angle of the light beam that is emitted from the light emitting portion. However, in this case there has been a problem in that this requires an increase in the photosensitive surface area of the light detecting portion, which greatly increases the cost of the position detecting device.

In contemplation of the situation described above, an object of at least some of the present inventions is to provide technological means for carrying out position detection of a vibrating portion without greatly increasing costs, even when the vibration stroke of the vibrating portion is long.

Some of the embodiments disclosed herein are directed to a position detecting device. The position detecting device can comprise at least one position detecting portion. In some embodiments, the position detecting portion includes a light emitting portion, a light detecting portion for detecting light that has been emitted from the light emitting portion, and a light blocking portion, attached to a vibrating portion and positioned between the light emitting portion and the light detecting portion, the light blocking portion having a width that increases gradually along a direction of vibration of the vibrating portion.

### BRIEF DESCRIPTIONS OF THE DRAWINGS

FIGS. 1A, 1B, and 1C are schematic diagrams illustrating movements of a position detecting device according to a first embodiment, viewed from the -y direction.

FIGS. 2A, 2B, and 2C are schematic diagrams illustrating movements of the position detecting device, viewed from the x direction.

FIG. 3 is a schematic diagram depicting a light blocking portion that is used in a position detecting device according to a second embodiment.

FIG. 4 is a graph illustrating the relationship between a reference position and a reference signal value for the position detecting signal in this embodiment.

FIG. 5 is a graph illustrating error calculated in this embodiment.

FIG. 6 is a graph illustrating a correction value calculated in this embodiment.

FIG. 7 is a graph illustrating the corrected edge position calculated in this embodiment.

FIG. 8 is a schematic diagram for explaining the operation of a diffusing plate used in a position detecting device according to a third embodiment.

FIG. 9 is a schematic diagram for explaining the operation of the diffusing plate.

FIGS. 10A, 10B, and 10C are schematic diagrams representing different views of a position detecting device according to this embodiment, during a state of operation.

FIGS. 11A, 11B, and 11C are schematic diagrams representing different views of a position detecting device according to this embodiment, during another state of operation.

FIGS. 12A, 12B, and 12C are schematic diagrams representing different views of a position detecting device according to this embodiment, during yet another state of operation.

FIG. 13 is a schematic diagram depicting the structure of a position detecting device according to a fourth embodiment.

FIG. 14 is a longitudinal sectional drawing depicting the structure of a speaker unit in which is mounted in a position detecting device according to a sixth embodiment.

FIG. 15 is a top plan view of the speaker unit, viewed from above.

FIG. 16 is an enlarged top plan view, viewed from above, of a speaker unit in which is mounted a position detecting device according to a seventh embodiment.

FIG. 17 is a longitudinal sectional drawing of the speaker unit.

FIG. 18 is a longitudinal sectional drawing of a speaker unit in which is mounted a position detecting device according to an eighth embodiment.

FIG. 19A is a side elevational view of the speaker unit, viewed from left the side and FIG. 19B is a side elevational view of the speaker unit, viewed from the right side.

FIG. 20 is an enlarged top plan view wherein the speaker unit is viewed from above.

FIG. 21 is a schematic diagram depicting the structure of a position detecting device according to a ninth embodiment.

FIG. 22 is a cross-sectional drawing along the section XXII-XXII of FIG. 21.

FIG. 23 is an overall diagram of a speaker system comprising a position detecting device according to a modified example.

### DETAILED DESCRIPTION OF PREFERRED EMBODIMENTS

Embodiments of the present inventions are explained below in reference to the drawings.

### First Embodiment

FIGS. 1A through C and FIGS. 2A through C are diagrams depicting the structure of a position detecting device 100A according to a first embodiment. This position detecting device 100A has a position detecting portion comprising a paired light emitting portion 1 and light detecting portion 2, and a light blocking portion 3. The light blocking portion 3 vibrates together with a vibrating portion (not shown) of a speaker, such as a voice coil, a paper cone, or the like, passing between the light emitting portion 1 and the light detecting portion 2. The light emitting portion 1 and the light detecting portion 2 are secured to a securing portion, such as, for example, the frame (not shown) of the speaker unit, or the like. In the present embodiment, the position detecting device 100A has a single position detecting portion; however, a plurality of position detecting portions may be provided in the position detecting device, such as in the sixth through eighth embodiments, set forth below.

The x direction, y direction, and z direction, which are mutually orthogonal in three-dimensional space, are shown in FIG. 1A through C and FIG. 2A through C. FIGS. 1A through C are diagrams wherein the position detecting device 100A is viewed from the y direction, and FIGS. 2A through C are diagrams wherein the position detecting device 100A is viewed from the x direction.

In FIGS. 1A through C and FIGS. 2A through C, the light emitting portion 1 is, for example, an LED, which emits a light beam 4 of a conical shape that advances as the diameter thereof increases. The optical axis 4ax that is the center of this light beam 4 extends in the x direction. The light detecting portion 2 is a phototransistor, a photodiode, or the like. The optical axis 4ax of the light beam 4 is perpendicular to the photosensitive surface at the center of the photosensitive surface of the light detecting portion 2. The light detecting portion 2 outputs a position detection signal of a strength that depends on the total amount of light received by the photosensitive surface.

The plane 5 is a virtual plane that is perpendicular to the optical axis 4ax of the light beam 4, and is positioned a distance A away from the light emitting portion 1 and a distance B away from the light detecting portion 2. The light blocking portion 3 vibrates together with the vibrating portion, and moves in the z direction or −z direction, shown in FIGS. 1A through C and FIGS. 2A through C, within the plane 5. The light blocking portion 3, when vibrating together with the vibrating portion, passes between the light emitting portion 1 and the light detecting portion 2 in a direction that is perpendicular to the optical path from the light emitting portion 1 to the light detecting portion 2, so as to cause a change in the amount of light that arrives at the light detecting portion 2 from the light emitting portion 1.

As depicted in FIGS. 2A through C, the light blocking portion 3 includes a right triangle portion characterized by an edge 3a that extends in the z direction, which is the direction of movement of the light blocking portion 3, an edge 3b that extends in the y direction that is perpendicular to the z direction and the x direction, and an edge 3e that is a diagonal edge between the edges 3a and 3b. Here the edge 3e is inclined by an angle θ with respect to the z direction that is the direction of movement of the light blocking portion 3. Given this, the light blocking portion 3 has a width that gradually increases from one end (the bottom end in FIG. 2) toward the other end (the top end in FIG. 2) along the z direction, which is the direction of vibration of the vibrating portion. Preferably this angle θ is no greater than 45°. Moreover, the cross-section of the light beam 4, in the plane 5, forms a circle with a radius R.

As depicted in FIGS. 2A through C, through the light blocking portion 3 moving in the −z direction along the plane 5, the edge 3e will pass through the light beam 4. Here the edge 3e functions as a boundary that divides a transparent region, through which the light beam 4 can pass without being blocked by the light blocking portion 3 from a light blocking region wherein the light beam 4 is blocked by the light blocking portion 3. As depicted in FIG. 2A through C, as the light blocking portion 3 moves in the −z direction and the edge 3e passes through the light beam 4, at this time the area of the transparent region is reduced, and the area of the light blocking region is increased, for the light beam 4. The result is that there will be a change in strength of the position detecting signal of the light detecting portion 2 depending on the change in position of the light blocking portion 3 in the ±z directions.

In FIG. 2A, the edge 3e is tangent to the arc of the left side (−y direction) of the circle that is the cross-section of the light beam 4. When this edge 3e moves from this position further in the −z direction, the area of the transparent region in the light beam 4 begins to be reduced and the area of the light blocking region in the light beam 4 begins to increase, so the strength of the position detection signal begins to fall from the maximum value.

In FIG. 2B, the edge 3e has moved from the position in FIG. 2A by an amount of R/tanθ in the -z direction, to contact the optical axis 4ax of the light beam 4. In this state, the area of the transparent region in the light beam 4 will be equal to the area of the light blocking region in the light beam 4, and the strength of the position detecting signal will be a strength that is between the maximum strength and the minimum strength.

In FIG. 2C, the edge 3e moved from the position in FIG. 2B by the amount of R/tanθ in the −z direction to be tangent to the arc on the right side (y direction) of the circle that is the cross-section of the light beam 4. In this state, the area of the transparent region in the light beam 4 will be zero, and the area of the light blocking region will be a maximum. Because of this, the strength of the position detecting signal will be the minimum strength.

In the present embodiment, if the angle between the edge 3e of the light blocking portion 3 and the direction of vibration of the vibrating portion is defined as θ, the range over which the position can be detected will be 2R/tanθ. Consequently, even if the radius R of the light beam 4 is not large, it will still be possible to achieve a required range 2R/tanθ for position detection by selecting θ to be an appropriate angle, preferably no greater than 45°. Moreover, because it is not necessary for the radius R of the light beam 4 to be large in the present embodiment, the size of the light detecting portion 2, in the direction of vibration of the vibrating portion, can be reduced, making it possible to avoid an increase in cost in the position detecting device 100A.

In the case of, for example, a ±5 mm vibration of a voice coil in a 20 cm woofer it is preferred for 2R/tan θ to be 10 mm in order to detect the position thereof. If here θ=15°, then tanθ=0.268, so 2R=2.68. In this case, the size 2R×(A+B)/A of the light detecting portion 2 in the direction of vibration of the vibrating portion need not be larger than 3 mm. Such a photodiode is readily available, enabling the position detecting device 100A to be structured at a low cost.

### Second Embodiment

In the first embodiment, set forth above, the amount of light received by the light detecting portion 2 will not be equal at all positions within the photosensitive surface, but rather will vary depending on the position. Because of this, when a straight edge 3e is moved, the change in strength of the position detection signal will be nonlinear in respect to the change in position of the edge 3e.

With reference to FIG. 3, in the present embodiment, the strength of the position detection signal can be caused to change linearly or more linearly with the change in position of the edge 203e through having the edge 203e of the light blocking portion 203 be curved. More specifically, in the present embodiment, the relationship between the position of the light blocking portion 203 and the position detecting signal can be caused to approach linearity through an iterative process of measuring the relationship between the position of the light blocking portion 203 and the position detection signal and reshaping the edge 203e of the light blocking portion 203 based on the measurement result.

FIG. 3 is a diagram depicting the light blocking portion 203 in the default state prior to reshaping, and the cross-sectional shape of the light beam 204 within the plane wherein the light blocking portion 203 moves. In the same manner as in FIG. 2A through C, presented above, FIG. 3 shows the z direction, which is the direction of movement of the light blocking portion 203, and the y direction, which is perpendicular to the z direction and to the direction of the optical axis 204ax of the light beam 204. In FIG. 3, the cross-sectional shape of the light beam 204 in the plane wherein the light blocking portion 203 moves forms a circle with a radius R. The light blocking portion 203 forms a right triangle wherein the edge in the y direction and the edge in the z direction are perpendicular, and where the edge 203e, which is the hypotenuse that is between the two edges that form the right triangle, having an incline of an angle θ in respect to the z direction. Given this, the light blocking portion 203 has a width that gradually increases from one end (the bottom end in FIG. 3) toward the other end (the top end in FIG. 3) along the z direction, which is the direction of vibration of the vibrating portion. In the present embodiment, the center point of this edge 203e is used as a reference position for the light blocking portion 203. Moreover, in the present embodiment, the point where the optical axis 204ax of the light beam 204 intersects the plane of movement of the light blocking portion 203 is defined as the origin (0, 0) of a y-z coordinate system.

In the example depicted in FIG. 3, the reference position for the light blocking portion 203 is positioned at the origin (0, 0). Through the light blocking portion 203 vibrating together with the vibrating portion, the reference position of the light blocking portion 203 will move along the z axis that passes through the origin (0, 0). The edge of the light blocking portion 203 in the z direction will be a distance of R+α, in the −y direction, from the reference position. Moreover, the edge of the light blocking portion 203 in the y direction will have one end at a position that is a distance of R+α in the −y direction from the z axis that passes through the origin (0, 0), with the other end at a position that is a distance of R+α in the +y direction from the z axis. When the reference position of the light blocking portion 203 moves in the ±z directions, the part of the light blocking portion 203 that is within a range of ±R in the y direction from the z axis that passes through the reference position will block the light beam 204. The region of ±a to the outside of this part is an attaching margin so that the component for attaching the light blocking portion 203 does not block the light beam 204.

In the state wherein the reference position is at the origin (0, 0), as depicted in FIG. 3, the edge 203e of the light blocking portion 203 passes through three points: (−R, −R/tanθ), 0, 0), and (R, R/tanθ).

In a process of operation, the z coordinate value of the reference position of the light blocking portion 203 and the position detection signal obtained from the light detecting portion 2 that detects the light beam 204 are measured while the light blocking portion 203 is stepped in the −z direction. The z coordinate value of the reference position of the light blocking portion 203 is normalized into a range of between 0% and 100%, and the signal value for the position detection signal is normalized into a range of between 0% and 100%.

Specifically, the difference between the position detection signal value when the reference position is at the origin (0, 0) and the position detection signal value when at the bottom most position (0, −R/tanθ) is calculated, and also the difference between the position detection signal value when the reference position is at the origin (0, 0) and the position detection signal value when at the top most position (0, R/tanθ) is calculated as well. Given this, the position detection signal values at the various positions are normalized, with the larger of the absolute values of these two differences being defined as 50%. A graph is drawn depicting the relationship between the normalized reference positions (hereinafter termed the “normalized positions”) and the normalized position detection signal values (hereinafter termed the “normalized signal values”). Additionally, if it is determined that there is clearly an offset produced in the position detection signal values at each of the points, then the graphing is carried out after removing the offset through calculations. FIG. 4 is a graph showing the relationship produced between the normalized positions (%) and the normalized signal values (%).

Next, in FIG. 4, an ideal straight line is calculated wherein the normalized signal values would be equal to the normalized positions, and the errors in the normalized signal values in FIG. 4 with respect to the normalized signal values on the ideal straight line (not shown), that is, the total differences of the proportions of the latter normalized signal values with respect to the former normalized signal values, are calculated. FIG. 5 is a graph showing the relationship between the normalized positions (%) and the errors (%) produced in this way.

Following this, correction values (%) are calculated wherein the signs of the errors (%), shown in FIG. 5, are inverted. FIG. 6 is a graph showing the relationships between the normalized positions (%) and correction values (%) produced in this way.

Following this, the y coordinate values of each of the edge positions on the edge 203e, depicted in FIG. 3, are corrected in accordance with the relationships between the normalized positions (%) and the correction values (%) that are depicted in FIG. 6. FIG. 7 shows a graph of the y coordinate values y1 of the edge positions after this correction and a graph of the y coordinate values y0 of the edge positions prior to correction. As with FIG. 4 through FIG. 6, in FIG. 7 the horizontal axis indicates the normalized z coordinate values of the reference position of the light blocking portion 203. On this axis, 0% corresponds to z=−R/tanθ, and 100% corresponds to z=R/tanθ. The vertical axis represents the normalized y coordinate value of the position of the edge that intersects the y axis through which the axis 204ax of the light beam 204 passes.

When the z coordinate value of the reference position of the light blocking portion 203 is −R/tanθ (0%), the y axis that passes through the origin (0, 0) will intersect the edge 203e at a position on the edge that is R/tanθ away from the reference position in the z direction and R away in the y direction. When the z coordinate value of the reference position of the light blocking portion 203 is 0 (50%), the y axis that passes through the origin (0, 0) intersects with the edge 203e at the position on the edge that is the reference position. When the z coordinate value of the reference position of the light blocking portion 203 is −R/tanθ (100%), the y axis that passes through the origin (0, 0) will intersect the edge 203e at a position on the edge that is R/tanθ away from the reference position in the z direction and R away in the −y direction.

Given this, y coordinate values y1 of corrected edge positions are calculated by correcting the y coordinate values y0 of the edge positions in the interval between the edge position that is R/tanθ away from the reference position in the z direction and R away in the −y direction and the edge position that is the reference position, using the correction values Δy0 for between the normalized position 0% (z=−R/tanθ) and 50% (z=0). Furthermore, y coordinate values y0 of corrected edge positions are calculated by correcting the y coordinate values y0 of the edge positions in the interval between the edge position that is the reference position and the edge position that is R/tanθ away from the reference position in the z direction and R away in the y direction, using the correction values Δy0 for between the normalized position 50% (z=0) and 100% (z=R/tanθ). Given this, a light blocking portion 203 is fabricated wherein the shape of the edge 203e has been corrected based on the graph of the y coordinate values y1 after correction in FIG. 7.

The causes of the errors in FIG. 5 are due to the intensity distribution within the light beam 204 and the detection sensitivity distribution of the light detecting portion 2. Because of this, there is no guarantee that the error will go to 0 through simply correcting the shape of the edge following a curve wherein the curve of the error has been inverted. Given this, a light blocking portion 203 wherein the shape of the edge has been subjected to a first-pass correction is manufactured, and used to evaluate the remaining error through performing the measurements again. This process is repeated until converging to being within a target numeric value (for example, 1%). Through this, a light blocking portion 203 wherein the relationship between the normalized position and the normalized signal value is linear or nearly linear, is produced.

As in the above, having the edge 203e of the light blocking portion 203 be of a curved shape makes it possible to control to a variety of output characteristics for the position detecting device depending on the amount of light detected by the light detecting portion 2. In particular, as in the second embodiment, having the edge 203e of the light blocking portion 203 be of a specific curved shape makes it possible to cause the strength of the position detection signal to vary more linearly in respect to a change in position of the edge 203e than if the edge 203e were straight.

### Third Embodiment

As with the embodiments set forth above, the position detecting device according to the present embodiment (FIGS. 8-11) has a light blocking portion 303B1 (FIG. 10C) that has an edge 303e that is at an angle in respect to the direction of vibration of the vibrating portion. Thus the light blocking portion 303B1 has a width that gradually increases from one end along the direction of vibration of the vibrating portion (the end portion in the downward direction in FIG. 10C through FIG. 12C) toward the other end (the end portion in the upward direction in FIG. 10C through FIG. 12C). In the present embodiment, minimization of the size of the light detecting portion 302 is achieved through the provision of a diffusing plate 303 in a region to the outside of the edge 303e in the light blocking portion 303B1.

The diffusing plate 303 may comprise, for example, a particle-type diffusing plate or a lens-type diffusing plate. While either of these types of diffusing plates may be used, in the present embodiment a lens-type diffusing plate is used and explained for ease of understanding. Prior to explaining the structure of the present embodiment, the effect of the lens-type diffusing plate used in the present embodiment is explained in detail.

In FIG. 8, the light emitting portion 301 is an LED with an attached lens, and the light detecting portion 302 is a PD (Photo Detector) with an attached lens. A phototransistor or a photodiode, for example, may be used for the PD. The light emitting portion 301 and the light detecting portion 302 face each other in a state wherein the respective optical axes are collinear (in a state wherein the optical axes are identical). Here the optical axis of the light emitting portion 301 is the axis that indicates the direction in which the intensity of the light is maximum, and the optical axis of the light detecting portion 302 is an axis that indicates the direction in which the photodetection sensitivity is maximum. In FIG. 8, the optical axis of the light emitting portion 301 and the optical axis of the light detecting portion 302 are shown as the joint optical axis 304ax. The diffusing plate 303 is a lens-type diffusing plate wherein a microlens is formed on the surface on the light emitting portion 301 side, and is perpendicular to the optical axis 304ax between the light emitting portion 301 and the light detecting portion 302.

In the example depicted in FIG. 8, the radiation angle of the light emitting portion 301 is ±28°, the directionality of the light detecting portion 302 is ±45°, the distances of the light emitting portion 301 and the light detecting portion 302 from the diffusing plate 303 are both 3 mm, and the diffusion angle of the diffusing plate 303 is ±60°. In this configuration, the light emitted from the light emitting portion 301 is incident on the diffusing plate 303 in a range with a diameter of 3.2 mm.

With continued reference to FIG. 9, a circular spot 303g with a diameter of 3.2 mm is formed on the back face of the diffusing plate 303, emitting the diffuse transmitted light. The light detecting portion 302 has directionality so as to detect light within an incident angle range of ±45°, and thus detects light within a circle 303h with a diameter of 6 mm centered on the point Pm on the diffusing plate 303.

Considering here the optical path at a point Pa that is at the edge of the spot 303g, the light that is emitted at an angle of 28° from the light emitting point Pe of the light emitting portion 301, as illustrated in FIG. 8, will be incident with an angle of 62° onto the point Pa of the diffusing plate 303, where the optical axis of this incident light will be emitted from the point Pa of the diffusing plate 303 with an angle of 62°. The diffuse light is diffused with an angle of ±60° in respect to the optical axis, so is diffused in a range between 2° and 122° with respect to the back face of the diffusing plate 303.

In the example in FIG. 8, a photodetection point Pr of the light detecting portion 302 is included within the range of the diffusion angle, and thus a portion of the light that is diffused to the PD side of the light detecting portion 302 is focused by the lens of the light detecting portion 302 to arrive at the photodetection point Pr. In the same manner, diffuse light from a point Pb on the opposite edge of the spot 303g will also arrive at the photodetection point Pr, and thus diffuse light from all positions between Pa and Pb will arrive at the photodetection point Pr. That which is described above applies to diffuse light from all positions within the spot 303g of the diffusing plate 303. Consequently, diffuse light from the entire range of the spot 303g will arrive at the photodetection point Pr.

FIG. 10 through FIG. 12 are diagrams depicting the state of transmission of light in the position detecting device 100C according to the present embodiment. In the present embodiment, a plate portion 303B, wherein a light blocking portion 303B1 and a diffusing portion 303B2 are adjacent with the edge 303e therebetween, divides between the light emitting portion 301 and the light detecting portion 302. The diffusing portion 303B2 is a lens type diffusing plate, and has a diffusion angle of ±60°. The light emitting portion 301 radiates a light beam 304 with a radiation angle of ±28°. The light detecting portion 302 comprises a PD with a photodetection angle of ±45°.

In FIG. 10 through FIG. 12, FIGS. 10A, 11A, and 12A show the state of emission of diffuse transmitted light on the back face of the plate portion 303B, when viewed from the PD of the light detecting portion 302, FIGS. 10B, 11B, and 12B show the state of propagation of the light beam between the light emitting portion 301 and the light detecting portion 302, and FIGS. 10C, 11C, and 12C show the light blocking portion 303B1, the diffusing portion 303B2, and the cross-sectional shape of the light beam 304 that is incident thereon.

In FIG. 10 through FIG. 12, the reference position of the light blocking portion 303B1 is stepped from the −5 mm position to the 5 mm position. Note that the definition of “reference position” is the same as in the second embodiment, set forth above.

As depicted in FIG. 10 through FIG. 12, the light beam 304, which is emitted from the light emitting portion 301 with a radiation angle of ±28°, is incident onto the light blocking portion 303B1 or the diffusing portion 303B2. When the reference position of the light blocking portion 303B1 is moved to the states of −5 mm, 0 mm, and 5 mm, the dimensions of the light beam, blocked by the light blocking portion 303B1, will vary to the states of 2.95 mm, 1.6 mm, and 0.26 mm. On the other hand, the portion of the light beam 304 incident on the diffusing portion 303B2 will be diffused by the diffusing portion 303B2, so as to arrive at the PD of the light detecting portion 302, as depicted in FIG. 10 through FIG. 12. Because of this, the cross-sectional area of the diffused transmitted light SP' on the back face of the plate portion 303B, when viewed from the PD of the light detecting portion 302, will be grow larger in accordance with the change in the reference position of the light blocking portion 303B1 from −5 mm, to 0 mm, to 5 mm, as depicted in FIG. 10 through FIG. 12.

In the present embodiment, the light beam 304 that is emitted from the light emitting portion 301 with a large radiation angle is diffused in a region with a broad area in the diffusing portion 303B2 that is connected to the light blocking portion 303B1, to arrive at the PD of the light detecting portion 302, which has a small photosensitive surface area. Because of this, the present embodiment enables the detection of the position of the vibrating portion in a speaker unit with a long stroke of vibration of the vibrating portion to be carried out without increasing the photosensitive surface area of the PD of the light detecting portion 302.

### Fourth Embodiment

FIG. 13 is a diagram depicting the structure of a position detecting device 100D according to a fourth embodiment according to the present invention. In FIG. 13, the light emitting portion 401 is an LED with an attached lens, and emits a light beam 404 with a radiation angle of ±28°. The light detecting portion 402 is a light detecting portion with an attached lens, and focuses light within an angular range of a photodetection angle of ±45° onto the PD. The light emitting portion 401 and the light detecting portion 402 face each other in a state wherein the respective optical axes are identical. The light blocking portion 403 is of a plate shape, and cuts across, in the direction that is perpendicular to the plane of the paper, a position that is 3 mm each away from the light emitting portion 401 and the light detecting portion 402, on the optical axis that connects between the light emitting portion 401 and the light detecting portion 402.

As with each of the embodiments set forth above, the light blocking portion 403 has an edge that is inclined with an angle of no greater than 45° with respect to a direction that is perpendicular to the plane of the paper, and that is the direction of vibration of the vibrating portion. Given this, the light blocking portion 403 has a width that gradually increases from one end toward the other end along the direction of vibration of the vibrating portion. The diffusing plate 406 is a flat diffusing plate that is perpendicular to the optical axis that connects the light emitting portion 401 and the light detecting portion 402, and is provided at a position between the light emitting portion 401 and the plane in which the light blocking portion 403 moves.

In FIG. 13, the edge of the light blocking portion 403 moves in a direction that is perpendicular to the plane of the paper, between points Pa and Pb. The point wherein a line segment passing between the point Pa and the photodetection point Pr of the light detecting portion 402 extends to intersect with the diffusing plate 406 is defined as a point Pj. Similarly, the point wherein a line segment passing between the point Pb and the photodetection point Pr of the light detecting portion 402 extends to intersect with the diffusing plate 406 is defined as a point Pk.

In this configuration, when the edge of the light blocking portion 403 moves between points Pa and Pb, the amount of diffused and transmitted light that arrives at the PD of the light detecting portion 402 from within the circle that passes through the points Pj and Pk in the diffusing plate 406 will vary in accordance with the movement of the edge.

Generally a particle-type diffusing plate is used for the diffusing plate 406, where a diffusing plate is used wherein, with φA as the diameter of the light beam that is incident onto the diffusing plate 406, the diameter φB of the emitted light beam that has been diffused and transmitted will be no less than the distance between the points Pj and Pk.

The shorter the distance between the diffusing plate 406 and the light blocking portion 403, the smaller the magnification ratios of φA and φB, and typically a diffusing plate is used that has high transparency. Consequently, the light blocking portion 403 and the diffusing plate 406 preferably are near to each other in a range wherein they do not collide with each other due to shaking during motion.

The same effects as in the embodiments set forth above are produced in the present embodiment as well. Moreover, in the present embodiment, only the light blocking portion 403 is coupled to the vibrating portion, where the diffusing plate 406 is not coupled to the vibrating portion, and thus there is the effect of reducing the amount of increase in vibrating mass.

### Fifth Embodiment

In the fourth embodiment, set forth above, the diffusing plate 406 was positioned between the plane of movement of the light blocking portion 403 and the light emitting portion 401. In contrast, in the present embodiment the diffusing plate 406 is provided at a position between the plane of movement of the light blocking portion 403 and the light detecting portion 402 (not shown). The same effect as in the fourth embodiment, set forth above, is produced in the present embodiment as well.

### Sixth Embodiment

FIG. 14 is a longitudinal sectional drawing of a speaker unit 1000A in which is mounted a position detecting device, according to a sixth embodiment, is sectioned by a plane that includes the axis of the speaker unit 1000A. FIG. 15 is a plan view when this speaker unit 1000A is viewed from the axial direction.

In this speaker unit 1000A, a bobbin 1001 is a round cylinder, with a coil 1002 wound onto a region on the bottom half thereof. The region wherein the coil 1002 is wound onto the bobbin 1001 is inserted into a magnetic gap between a pole piece 1010 and a yoke 1011. When power is applied to the coil 1002, the bobbin 1001 vibrates in the direction that is perpendicular to the plane of the paper.

The light blocking portion 1100 is in the form of a “+” shape, when viewed from above, having two plates of identical shapes crossing each other perpendicularly. The four end portions of the “+” shape of the light blocking plate portion 1100 are secured to the top end of the bobbin 1001. Having the light blocking plate portion 1100 be of the “+” shape is because this is suitable in terms of the balance of strength and weight in the bobbin 1001 to which the light blocking plate portion 1100 is secured.

A pair of plate-shaped light blocking portions 1101 and 1102 that extend downward in spatial regions in the vicinity of the inner wall of the bobbin 1001 is provided in the vicinities of two of the end portions that are diagonally opposite of each other, among the four end portions of the “+” shape of the light blocking plate portion 1100. These light blocking portions 1101 and 1102 have edges 1101e and 1102e that are at an angle in respect to the direction of vibration of the bobbin 1001 that is the vibrating portion (that is, the vertical direction in the plane of the paper). Thus the light blocking portions 1101 and 1102 each have widths that gradually increase from one end toward the other end along the direction of vibration of the vibrating portion. Note that the direction in which the width of the light blocking portion 1101 increases is opposite of the direction in which the width of the light blocking portion 1102 increases. That is, for the edge 1101e the inner region that approaches the vibrational axis of the speaker unit 1000A from the edge 1101e serves as a light blocking region for the light blocking portion 1101, and the width of the light blocking region is narrower the further toward the top in the plane of the paper. In contrast, for the edge 1102e the outer region that moves away from the vibrational axis of the speaker unit 1000A from the edge 1102e serves as a light blocking region for the light blocking portion 1102, and the width of the light blocking region is wider the further toward the top in the plane of the paper.

A sensor supporting platform 1020 has a vertical leg portion 1021 that is secured in a state that is standing on the center of the top end of the pole piece 1010, and a horizontal arm portion 1022 that extends from the top end of the vertical leg portion 1021 to the vicinities of the inner walls of the bobbin 1001 on both sides in the horizontal direction. With reference to FIG. 15, one end portion of the horizontal arm portion 1022 is branched into a first supporting portion 1031 and a second supporting portion 1032, and the other end portion is branched into a third supporting portion 1033 and a fourth supporting portion 1034. In the present embodiment, the sensor supporting platform 1020 serves as a structure securing portion for securing a light emitting portion and a light detecting portion, described below, to the speaker unit 1000A.

The first supporting portion 1031 and the second supporting portion 1032 face each other with the light blocking portion 1101 interposed therebetween. A light emitting portion 2001a and a light detecting portion 2002a are secured, in a state wherein the respective optical axes are identical, to respective opposing faces of the first supporting portion 1031 and the second supporting portion 1032. An edge 1101e of the light blocking portion 1101 cuts across the optical axis that connects between the light emitting portion 2001a and the light detecting portion 2002a.

Similarly, the third supporting portion 1033 and the fourth supporting portion 1034 face each other with the light blocking portion 1102 interposed therebetween. A light emitting portion 2001b and a light detecting portion 2002b are secured, in a state wherein the respective optical axes are identical, to respective opposing faces of the third supporting portion 1033 and the fourth supporting portion 1034. An edge 1102e of the light blocking portion 1102 cuts across the optical axis that connects between the light emitting portion 2001b and the light detecting portion 2002b.

As depicted in FIG. 15, the light emitting portions 2001a and 2001b are positioned on mutually opposing sides in respect to the diameter of the bobbin 1001. This is to prevent crosstalk wherein light emitted from the light emitting portion 2001a is received by the light detecting portion 2002b or light emitted from the light emitting portion 2001b is detected by the light detecting portion 2002a.

In the present embodiment, the light emitting portion 2001a, the light detecting portion 2002a, and the light blocking portion 1101 form a first position detecting portion, and the light emitting portion 2001b, the light detecting portion 2002b, and the light blocking portion 1102 form a second position detecting portion. Additionally, in the present embodiment, the direction in which the width of the light blocking portion 1101 increases is opposite of the direction in which the width of the light blocking portion 1102 increases. Thus the directions in which the amounts of light blocked by the respective light blocking portions 1101 and 1102 change, with respect to the direction of vibration, are opposite to each other. In addition, the position detecting device according the present embodiment comprises a difference detecting portion 1103. This difference detecting portion 1103 detects the difference between the output signal of the light detecting portion 2002a of the first position detecting portion and the output signal of the light detecting portion 2002b of the second position detecting portion, to output the difference as a position detection signal.

In FIG. 14, when the bobbin 1001 moves upward, the amount of light blocked by the light blocking portion 1101 increases, thus reducing the signal strength of the output signal of the first position detecting portion, and the amount of light blocked by the light blocking portion 1102 is reduced, and thus the signal strength of the output signal of the second position detecting portion increases. The result is that the signal strength of the position detection signal from the difference detecting portion 1103, wherein the output signal of the second position detecting portion is subtracted from the output signal of the first position detecting portion, is reduced.

In contrast, when the bobbin 1001 moves downward, the amount of light blocked by the light blocking portion 1101 decreases, thus increasing the signal strength of the output signal of the first position detecting portion, and the amount of light blocked by the light blocking portion 1102 is increased, and thus the signal strength of the output signal of the second position detecting portion decreases. The result is that the signal strength of the position detection signal from the difference detecting portion 1103, wherein the output signal of the second position detecting portion is subtracted from the output signal of the first position detecting portion, is increased. In this way, a position detection signal is produced wherein the signal strength will vary in accordance with the change in position of the bobbin 1001.

On the other hand, if the bobbin 1001 were to sway to the side, noise would be produced wherein the output signal of the first position detecting portion and the output signal of the second position detecting portion would be of about the same magnitude. For example, in the case in FIG. 14 wherein there is swaying from the left side in the plane of the paper toward the right side, the amount of light blocked by the light blocking portion 1101 and the amount of light blocked by the light blocking portion 1102 would both be reduced by about the same amount. As a result, there will be about the same increases in the strengths of each of the signals for the output signal from the first position detecting portion and the output signal from the second position detecting portion.

Because, in the present embodiment, the directions of change of the amounts of light blocked by the light blocking portions 1101 and 1102, with respect to the direction of vibration, are mutually opposite, the directions of change in the output signal from the first position detecting portion and in the output signal from the second position detecting portion, with respect to the direction of vibration, will be mutually opposite. The difference detecting portion 1103 outputs, as the position detection signal, the difference between the output signal from the first position detecting portion and the output signal from the second position detecting portion. As a result, there is the effect of reducing variation of the electrical center point of the position detection signal with respect to various types of variability, such as variability in the brightness of the LED, variability in detection sensitivity of the PD, and like, with respect to variations in power supply voltage and variations in temperature.

Let us consider the case wherein a position detection signal is outputted from a single end-type amplifier. In such a case, there would be a shift in the electrical center point and mechanical center point if there were a variation in the sensitivity of the detection system. This could cause a continuous DC current to flow in the coil, through the use of the position detection signal as a reference value, which would cause heating of the coil, even if no audio signal were inputted into the speaker unit. Moreover, if the vibration were held for an extended period of time at a position that is offset from the mechanical center point, this could cause deformation of the damper and of the suspension system. Moreover, an error in detection sensitivity would appear as distortion in the speaker audio after application of MFB. In contrast, in the present embodiment, the difference detecting portion 1103 outputs, as the position detection signal, the difference between the output signal from the first position detecting portion and the output signal from the second position detecting portion. Because of this, noise produced in the two output signals cancel each other out, making it possible to reduce or prevent the occurrence of such problems.

Moreover, in the present embodiment, the directions of change in the amounts of light blocked, with respect to the directions perpendicular to the direction of vibration, are mutually identical for the two light blocking portions 1101 in 1102 that are paired. Because of this, if the vibrating portion were to sway to the side, noises of identical phases, caused by this swaying to the side, would be produced in the output signal from the first position detecting portion and the output signal from the second position detecting portion, and these in-phase noises would be canceled out by the difference detecting portion. Consequently, this can prevent the effect of swaying to the side from appearing in the position detection signal.

Note that in the present embodiment, the directions of change in the amount of light blocked, in respect to the directions that are perpendicular to the direction of vibration, are identical in the light blocking portions 1101 and 1102, to produce the effect of preventing the effects of swaying to the side from appearing in the position detection signal; however, if this effect is not necessary, then the directions of change in the amount of light blocked, in respect to the directions that are perpendicular to the direction of vibration, may instead be opposite directions in the light blocking portions 1101 and 1102.

### Seventh Embodiment

FIG. 16 is a plan view, from above, of a speaker unit 1000B in which is mounted a position detecting device according to a seventh embodiment. Moreover, FIG. 17 is a longitudinal cross-sectional drawing wherein this speaker unit 1000B is sectioned by a plane that includes the axis thereof. Note that in these figures, those parts corresponding to the parts depicted in FIG. 14 and FIG. 15, presented above, use identical reference symbols, and explanations thereof will be omitted.

As depicted in FIG. 17, a paper cone 1202 is secured, in the center part thereof, to the top end of a bobbin 1001, and the peripheral parts thereof are secured to a frame 1200 through an edge 1201. In the present embodiment, light blocking portions 1101 and 1102 are secured to two locations, which have a diagonal relationship, in the vicinity of the peripheral parts on the backside of the paper cone 1202. As with the sixth embodiment, described above, the light blocking portions 1101 and 1102 have edges 1101e and 1102e that are inclined in respect to the direction of vibration of the bobbin 1001. Because of this, the light blocking portions 1101 and 1102 have widths that gradually increase from one end toward the other end thereof along the direction of vibration of the vibrating portion. Note that the direction in which the width of the light blocking portion 1101 increases is opposite of the direction in which the width of the light blocking portion 1102 increases. The directions in which the positions of the edges 1101e and 1102e change, with respect to the direction of vibration of the bobbin 1001, are mutually opposite. Consequently, with these light blocking portions 1101 and 1102, the directions in which the amounts of light blocked change, with respect to the direction of vibration, are mutually opposite. Moreover, in the light blocking portions 1101 and 1102, the directions in which the amounts of light blocked change, with respect to the directions that are perpendicular to the direction of vibration, are mutually the same directions, in the same manner as in the sixth embodiment, set forth above.

A sensor supporting portion 1041, for supporting a light emitting portion 2001a and a light detecting portion 2002a, and a sensor supporting portion 1042, for supporting a light emitting portion 2001b and a light detecting portion 2002b, are secured to a frame 1200.

In the frame 1200, windows or holes are provided through which pass the respective bottom ends of the light blocking portions 1101 and 1102 when moved downward through vibration.

In the normal state wherein no audio signal is inputted, the light blocking portions 1101 and 1102 will be contained within the frame 1200. Because of this, there is no particular need for special care when handling the speaker unit 1000B, or when assembling into a speaker system.

Because either the light emitting portions 2001a and 2001b or the light detecting portions 2002a and 2002b are secured to the frame 1200, there is no need to use tinsel wires in connecting for the light emitting portions and the light detecting portions.

### Eighth Embodiment

FIG. 18 is a longitudinal sectional drawing of a speaker unit 1000C in which is mounted a position detecting device according to an eighth embodiment, sectioned by a plane that includes the axis thereof. FIG. 19A is an elevational view of the light blocking portion 1101 within the speaker unit 1000C, from the left side in FIG. 18, and FIG. 19B is an elevational view of the light blocking portion 1102 within the speaker unit 1000C, from the right side in FIG. 18. FIG. 20 is a top plan view of the speaker unit 1000C from above. Note that in these figures, those parts corresponding to the parts depicted in FIG. 16 and FIG. 17, presented above, use identical reference symbols, and explanations thereof will be omitted.

In the present embodiment, as depicted in FIG. 19A and B, a light blocking portion 1101 that has an edge 1101e, and a light blocking portion 1102 that has an edge 1102e, are formed on the surface of a bobbin 1001. Kapton® resin is often used as a bobbin material, and browned Kapton® resin will have transparency of 80% or more in the infrared domain. Because of this, when a bobbin 1001 that has high transparency in the infrared domain is used, and LEDs that emit light in the infrared domain are used as the light emitting portions 2001a and 2001b, and phototransistor that are sensitive to the infrared domain are used as the light detecting portions 2002a and 2002b, it would be possible for light to pass through to the bobbin 1001 without formation of a hole. Printing may be performed, or a light blocking sticker may be applied, to block the light on the outer surface or inner surface of the bobbin 1001 to form the light blocking portions 1101 and 1102.

Within the bobbin 1001, a supporting platform 1030 is secured to a pole piece 1010. The supporting platform 1030 is structured from a vertical portion that is perpendicular to the top face of the pole piece 1010, and a horizontal portion that extends from the top of the vertical portion toward both sides in the horizontal direction to the vicinity of the inner wall of the bobbin 1001. Light emitting portions 2001a and 2001b that emit light beams toward the regions where light blocking portions 1101 and 1102 are formed on the inner wall of the bobbin 1001 are secured to both ends of the horizontal portion of the supporting platform 1030.

On the outside of the bobbin 1001, light detecting portions 2002a and 2002b are secured to supporting portions 1041 and 1042, which are secured to the frame 1200. Given this, the light emitting portion 2001a and the light detecting portion 2002a face each other, with the optical axes thereof being identical, with the bobbin 1001 interposed therebetween. Similarly, the light emitting portion 2001b and the light detecting portion 2002b face each other, with the optical axes thereof being identical, with the bobbin 1001 interposed therebetween.

As with the sixth embodiment, set forth above, the directions of change of the amounts of light blocked by the edges, in respect to the direction of vibration of the bobbin 1001, are mutually opposite for the edge 1101e of the light blocking portion 1101 and the edge 1102e of the light blocking portion 1102.

In the present embodiment, no hole is formed in the bobbin 1001, and thus no noise will be produced by air flowing in and out. Moreover, there is no need to apply a tinsel wire in order to equip on the stationary side, for either the light emitting portions 2001a and 2001b or the light detecting portion 2002a or 2002b. Note that while, in the present embodiment, the light emitting portions 2001a and 2001b are provided in the interior of the bobbin 1001 and the light detecting portions 2002a and 2002b are provided on the outside of the bobbin 1001, the positional relationships between the light emitting portions and the light detecting portions may instead be reversed. Because the light emitting portions or light detecting portions that are provided on the outside of the bobbin 1001 are provided between the diaphragm and the damper, it is more beneficial to provide a damper on the voice coil side than it is in a normal unit, and the height of the voice coil may be increased somewhat.

### Ninth Embodiment

A position detecting device 100F according to a ninth embodiment is explained next with reference to FIG. 21 and FIG. 22. While in the embodiments described above, the position of a vibrating portion that vibrates linearly was detected, in the position detecting device 100F according to the ninth embodiment, a position of rotation of a vibrating portion that undergoes angular vibration is detected. FIG. 21 is a plan view, from a direction that is perpendicular to the axis A1, of a vibrating portion 500 that undergoes angular vibration, and of a position detecting device 100F that is attached thereto. FIG. 22 is a cross-sectional drawing along the section XXII-XXII of FIG. 21.

The vibrating portion 500 of the present embodiment is a shaft unit that has an axis Al, and vibrates around the axis Al. That is, the vibrating portion 500 vibrates through rotating in the clockwise and counterclockwise directions around the axis A1. In this way, the vibrating portion 500 is a shaft unit that undergoes angular motion, and in the below the vibrating portion 500 will be termed a rotating shaft 500.

The position detecting device 100F comprises light emitting portions 501a and 501b, light detecting portions 502a and 502b, light blocking portions 503a and 503b, and a diffusing plate 504. The light emitting portion 501a, the light detecting portion 502a, and the light blocking portion 503a, together with a diffusing plate 504, form a first position detecting portion, and the light emitting portion 501b, the light detecting portion 502b, and the light blocking portion 503b, together with the diffusing plate 504, form a second position detecting portion.

The light emitting portion 501a and light detecting portion 502a face each other in a state wherein the optical axes are identical, and the light emitting portion 501b and the light detecting portion 502b also face each other in a state wherein the optical axes are identical. The diffusing plate 504 is of a disk shape, and is disposed coaxially with the axis Al of the rotary shaft 500, and is secured to the rotary shaft 500. Thus the diffusing plate 504 undergoes angular vibration together with the rotary shaft 500. The diffusing plate 504 is optically transparent, and, as with the diffusing plates 303, 406, and 407, has the ability to diffuse light.

The light emitting portion 501a and the light detecting portion 502a are disposed, with the diffusing plate 504 therebetween, so that the optical axes thereof are perpendicular to the diffusing plate 504. The light emitting portion 501b and the light detecting portion 502b are also disposed, with the diffusing plate 504 therebetween, so that the optical axes thereof are perpendicular to the diffusing plate 504. Spots 505a and 505b, for the respective light beams emitted from the light emitting portions 501a and 501b, are formed on the diffusing plate 504. Diffuse light from the entirety of the ranges of the respective spots 505a and 505b arrive at the light detecting portions 502a and 502b.

When viewed from the direction that is perpendicular to the axis A1, the light emitting portion 501a and the light detecting portion 502a are positioned in the vicinity of the outer peripheral portion of the diffusing plate 504, and the light emitting portion 501b and the light detecting portion 502b are also positioned in the vicinity of the outer peripheral portion of the diffusing plate 504. The light emitting portion 501a and the light detecting portion 502a are disposed at positions separated by 180°, around the axis A1, with respect to the light emitting portion 501b and the light detecting portion 502b.

Moreover, the light emitting portions 501a and 501b are disposed on opposite sides of the diffusing plate 504, and the light detecting portion 502a and 502b are also disposed on opposite sides of the diffusing plate 504. This prevents crosstalk wherein light emitted by the light emitting portion 501a is detected by the light detecting portion 502b and light emitted from the light emitting portion 501b is detected by the light detecting portion 502a.

The light blocking portions 503a and 503b are secured onto the diffusing plate 504, and undergo angular vibration together with the rotary shaft 500 and the diffusing plate 504. The light blocking portions 503a and 503b can be embodied by, for example, a light blocking sheet that is adhered onto the diffusing plate 504. The light blocking portions 503a and 503b in the present embodiment, each have a width of approximately 90° in the circumferential direction, in respect to the axis A1, and are separated from each other by about 90° in the circumferential direction, in respect to the axis A1. Note that unless otherwise noted, in the explanation below the “circumferential direction” and the “radial direction” are defined with respect to the axis A1.

During angular vibration, the light blocking portion 503a passes between the light emitting portion 501a and the light detecting portion 502a in a direction that crosses (is perpendicular to) the optical path from the light emitting portion 501a to the light detecting portion 502a, and the amount of light that arrives at the light emitting portion 501a from the light detecting portion 502a is varied thereby. Similarly, during angular vibration, the light blocking portion 503b passes between the light emitting portion 501b and the light detecting portion 502b in a direction that crosses (is perpendicular to) the optical path from the light emitting portion 501b to the light detecting portion 502b, and the amount of light that arrives at the light emitting portion 501b from the light detecting portion 502b is varied thereby.

The light blocking portion 503a has a width that increases gradually along the direction of vibration of the vibrating portion 500, that is, from a first end 511 toward a second end 512 along the circumferential direction. Similarly, the light blocking portion 503b has a width that increases gradually along the direction of vibration of the vibrating portion 500, that is, from a first end 513 toward a second end 514 along the circumferential direction. Here “width” refers to the length in the direction that is perpendicular to the direction of vibration of the light blocking portion 503a, that is, along the radial direction. Note that the second end 512, the first end 511, the first end 513, and the second end 514 exist in that order, in the clockwise direction, with reference to the axis A1.

The light blocking portion 503a has an edge 520a that, during angular vibration, passes through a light beam that is emitted from the light emitting portion 501aand detected by the light detecting portion 502a. In other words, the edge 520a passes over the spot 505a. The light blocking portion 503a is disposed, on the diffusing plate 504, to the inside of the edge 520a in the radial direction. On the other hand, the region on the diffusing plate 504 that is to the outside of the edge 520a in the radial direction is an optically transparent region wherein the surface of the diffusing plate 504 is exposed. The edge 520a is coincident with the outer peripheral edge of the diffusing plate 504 at the second end 512, and gradually moves away from the outer peripheral edge of the diffusing plate 504 along the circumferential direction from the second end 512 toward the first end 511. Through this, the amount of light that arrives at the light detecting portion 502a from the light emitting portion 501a is gradually reduced when the rotary shaft 500 rotates in the clockwise direction, and gradually increases when the rotary shaft 500 rotates in the counterclockwise direction.

On the other hand, the light blocking portion 503b has an edge 520b that, during angular vibration, passes through a light beam that is emitted from the light emitting portion 501b and detected by the light detecting portion 502b. In other words, the edge 520b passes over the spot 505b. The light blocking portion 503b is disposed to the outside, in the radial direction, of the edge 520b over the diffusing plate 504. On the other hand, the region on the diffusing plate 504 that is to the inside of the edge 520b in the radial direction is an optically transparent region wherein the surface of the diffusing plate 504 is exposed. The edge 520b overlays the outer peripheral edge of the diffusing plate 504 at the first end 513, and when it moves along the peripheral direction from the first end 513 toward the second end 514, it gradually moves away from the outer peripheral edge of the diffusing plate 504. Through this, the amount of light that arrives at the light detecting portion 502b from the light emitting portion 501b gradually increases when the rotary shaft 500 rotates in the clockwise direction, and is gradually decreased when the rotary shaft 500 rotates in the counterclockwise direction.

Given the above, in the circumferential direction, that is, in the directions in which the amounts of light blocked changes with respect to the direction of vibration of the vibrating portion 500, the light blocking portion 503a and 503b are mutually opposite. Moreover, the directions in which the amounts of light blocked change with respect to the radial direction that is perpendicular to the direction of vibration of the vibrating portion 500 are mutually identical for the light blocking portions 503a and 503b. Moreover, as with the sixth embodiment, the light detecting portions 502a and 502b are connected to a difference detecting portion 1103. The difference detecting portion 1103 detects a difference by subtracting the output signal from the light detecting portion 502b of the second position detecting portion from the output signal of the light detecting portion 502a of the first position detecting portion, to output the difference as the position detection signal.

Given this, when the rotary shaft 500 rotates in the clockwise direction, the signal strength of the output signal of the first position detecting portion is reduced and the signal strength of the output signal of the second position detecting portion increases. The result is a reduction in the signal strength of the position detection signal from the difference detecting portion 1103. On the other hand, when the rotary shaft 500 rotates in the counterclockwise direction, the signal strength of the output signal of the first position detecting portion increases and the signal strength of the output signal of the second position detecting portion is decreased. The result is an increase in the signal strength of the position detection signal from the difference detecting portion 1103. Thus a position detection signal is produced wherein the signal strength changes in accordance with a change in the angular position of the rotary shaft 500.

Moreover, the edge 520a has a curved shape so that the output signal value from the light detecting portion 502a will change linearly with a change in the angular position of the vibrating portion 500, and the edge 520b also has a curved shape so that the output signal value from the light detecting portion 502b will change linearly in respect to a change in the angular position of the vibrating portion 500. These curved shapes may be identified through a method that is similar to that in the second embodiment.

### Other Embodiments

While the present inventions have been explained in the context of various embodiments, the present inventions may be embodied in other ways as well. For example, the present inventions may be applied to a position detecting device of a linear fader of an audio mixer. In this case, the position detection signal may be converted into a digital signal, and an electronic volume may be controlled through this digital signal. In this case, the position of the linear fader is detected in a non-contact state, enabling an improvement in durability. Moreover, the present inventions may be applied in general to products that require accurate position detection of high amplitudes in a noisy or electromagnetically noisy environment.

Moreover, the position detecting devices according to the various embodiments described above (hereinafter indicated by reference symbol 100, as a general symbol) can be used in detection of positions of a variety of vibrating elements, and they may be used in MFB control of, for example, speaker units (hereinafter indicated by reference symbol 1000, as a general symbol). FIG. 23 shows an overall diagram of a speaker system 10 comprising a position detecting device 100 according to any of the above embodiments. The speaker system 10 comprises not only a speaker unit 1000 and a position detecting device 100 that is attached thereto, but also a controlling portion 12 and an amplifier 11.

The controlling portion 12 generates an input signal that is inputted into the speaker unit 1000. The input signal generated by the controlling portion 12 is inputted into the speaker unit 1000 after amplification by an amplifier 11. The speaker unit 1000 outputs audio in accordance with the input signal. In this case, the vibrating portion of the speaker unit 1000 vibrates, and the position of the vibrating portion in this case is detected by the position detecting device 100. Specifically, the light detecting portion (hereinafter indicated by reference symbol 2, as a general symbol) or the difference detecting portion 1103, included in the position detecting device 100, outputs a position detection signal indicating the position of the vibrating portion, and this position detection signal is transmitted to the controlling portion 12. The controlling portion 12 performs MFB control of the speaker unit 1000 through controlling, in accordance with this position detection signal, the input signal that is inputted into the speaker unit 1000.

What is claimed is:

1. A position detecting device comprising:
at least one position detecting portion, wherein:
the position detecting portion includes:
a light emitting portion;
a light detecting portion for detecting light emitted from the light emitting portion; and
a light blocking portion, attached to a vibrating portion and positioned between the light emitting portion and the light detecting portion, having a width that gradually increases along a direction of vibration of the vibrating portion.

2. A position detecting device as set forth in claim 1, wherein:
the light blocking portion has an edge that passes through a light beam that is emitted from the light emitting portion and is detected by the light detecting portion when the light blocking portion vibrates together with the vibrating portion; and
the edge has a curved shape.

3. A position detecting device as set forth in claim 2, wherein:
the edge has a curved shape such that an output signal value of the light detecting portion changes linearly in respect to a change in position of the vibrating portion.

4. A position detecting device as set forth in claim 1, wherein:
the position detecting portion further includes a diffusing plate that is disposed between the light emitting portion and the light detecting portion.

5. A position detecting device as set forth in claim 1, comprising:
at least two position detecting portions that form a pair, as the at least one position detecting portion, wherein:
the light blocking portion comprises at least two light blocking portions included respectively in the at least two position detecting portions that form a pair, the direction in which the width increases of the at least two light blocking portions, with respect to the direction of vibration, are mutually opposite; wherein
the position detecting device further comprises a difference detecting portion for detecting a difference in the output signals of the light detecting portions that are included respectively in the two position detecting portions that form the pair.

6. A speaker system comprising:
a position detecting device as set forth in claim 1; and
a speaker unit that includes the vibrating portion.

7. A speaker system comprising:
a position detecting device as set forth in claim 5; and
a speaker unit that includes the vibrating portion.

8. A speaker system as set forth in claim 7, further comprising:
a controlling portion for performing motion feedback control of the speaker unit in accordance with a position detection signal detected by the position detecting device.

9. A position detecting device comprising:
at least a first position detecting assembly, comprising:
a first light emitter;
a first light detector configured to detect light emitted from the first light emitter; and
a first light blocking portion attached to a vibrating member, the first light blocking portion being positioned between the first light emitter and the first light detector, the first light blocking portion having a first width that gradually increases along a first direction of vibration of the vibrating member.

10. The position detecting device as set forth in claim 9, wherein the first light blocking portion comprises a first edge positioned to pass across a light beam emitted from the first light emitter when the first light blocking portion is moved by the vibrating member along the first direction of vibration, the first light detector being configured to detect movement of the first edge across the light beam when the first light blocking portion vibrates together with the vibrating member, wherein the first edge comprises a first curved shape.

11. The position detecting device as set forth in claim 10, wherein the first curved shape of the first edge is shaped such that an output signal value of the first light detector changes linearly with respect to a change in position of the vibrating member.

12. The position detecting device as set forth in claim 9, wherein the first position detecting assembly further comprises a first diffusing plate disposed between the first light emitter and the first light detector.

13. The position detecting device as set forth in claim 9 further comprising a second position detecting assembly forming a pair with the first position detecting assembly, the second position detecting assembly comprising:
a second light emitter;
a second light detector configured to detect light emitted from the first light emitter; and
a second light blocking portion attached to the vibrating member, the second light blocking portion positioned between the second light emitter and the second light detector, the second light blocking portion having a second width that gradually increases along a second direction of vibration of the vibrating member;
wherein the first and second directions of vibration in which the first and second widths increase, respectively, with respect to the direction of vibration, are mutually opposite.

14. The position detecting device as set forth in claim 13 further comprising a difference detecting portion connected to the first and second light detectors and configured to detect a difference in signals output from the first and second light detectors.

15. The position detecting device as set forth in claim 9 in combination with a speaker system comprising a speaker unit, wherein the vibrating portion forms a part of the speaker unit.

16. The position detecting device as set forth in claim 14 in combination with a speaker system comprising a speaker unit, wherein the vibrating portion forms a part of the speaker unit.

17. The position detecting device as set forth in claim 16 further comprising a controller configured to perform motion feedback control of the speaker unit in accordance with a position detection signal detected by the position detecting device.
